(19) United States
(12) Patent Application Publication
(10) Pub. No.: US 2009/0127215 A1
(43) Pub. Date: May 21, 2009

(54) VERTICAL BOOT STORAGE SYSTEM

(76) Inventor: Maria Moss Gale, Woodland Hills, CA (US)

Correspondence Address: IP Authority, LLC;Ramraj Soundararajan, 4821A Eisenhower Ave, Alexandria, VA, 22304, US

(21) Appl. No.: 12/272,241

(22) Filed: Nov. 17, 2008

Related U.S. Application Data
(60) Provisional application No. 60/988,143, filed on Nov. 15, 2007.

(51) Int. Cl. A47F 7/19; F16M 13/00

(52) U.S. Cl. 211/85.3; 248/158

(57) ABSTRACT

A floor-to-ceiling pole with a metal grid shell is disclosed, upon which pegboard-style hooks with attached clamps are hung. Clamps are used to hold individual pairs of boots and the hooks can be placed on the pole as needed by an individual. The grid can be detached via screws at the top and bottom for cleaning.

### RELATED APPLICATIONS

This application claims priority from U.S. Provisional Application 60/988,143 filed Nov. 15, 2007.

### BACKGROUND OF THE INVENTION

1. Field of Invention

The present invention relates generally to the field of storage of footwear. More specifically, the present invention is related to an apparatus for vertical boot storage.

2. Discussion of Prior Art

The prior art fails to provide for a simple, cost-effective, floor-to-ceiling type structure that is used to store items such as footwear. Whatever the precise merits, features, and advantages of prior art storage devices, none of them achieves or fulfills the purposes of the present invention.

### SUMMARY OF THE INVENTION

The present invention provides for a vertical boot storage system comprising: (a) a floor-to-ceiling pole having a plurality of screw retention mechanisms disposed thereon, (b) a base engaging with a bottom part of the floor-to-ceiling pole to retain it to a floor; (c) a wire grid shell having a plurality of apertures wrapped around the floor-to-ceiling pole, the wire grid held in place using a plurality of screws, each screw having a head that is larger than each of the apertures and a body, and each screw inserted into an aperture such that the body of the screw engages a screw retention mechanism disposed on the floor-to-ceiling pole; and (d) a plurality of hooks, each hook inserted into an aperture, and each hook having a clamp to retain a pair of shoes. In an extended embodiment, the floor-to-ceiling pole has a protective rubber tip that is located at the top and/or bottom of the floor-to-ceiling pole.

The present invention also provides for a vertical boot storage system comprising: (a) a floor-to-ceiling polycarbonate pole having a plurality of screw retention mechanisms disposed thereon; (b) a base engaging with a bottom part of the floor-to-ceiling polycarbonate pole to retain it to a floor, the base having a plurality of holes for inserting a plurality of screws to aid in retaining the floor-to-ceiling polycarbonate pole to a floor; (c) a first protective rubber tip engaging a top part of the polycarbonate floor-to-ceiling pole to retain it to a ceiling and a second protective rubber tip engaging a bottom part of the polycarbonate floor-to-ceiling pole to retain it to a floor; (d) a wire grid shell having a plurality of apertures wrapped around the polycarbonate floor-to-ceiling pole, the wire grid shell held in place using a plurality of screws, each screw having a head that is larger than each of the apertures and a body, and each screw inserted into an aperture among such that the body of the screw engages a screw retention mechanism disposed on the polycarbonate floor-to-ceiling pole; and (e) a plurality of pegboard-style hooks, each pegboard-style hook inserted into an aperture, and each pegboard-style hook having a clamp to retain a pair of shoes.

The present invention also provides for a method of assembling a vertical boot storage comprising: (a) assembling a floor-to-ceiling polycarbonate pole with a base and a first and second protective rubber tips, the floor-to-ceiling polycarbonate pole having a plurality of screw retention mechanisms disposed thereon, the base engaging with a bottom part of the floor-to-ceiling polycarbonate pole to retain it to a floor, the base having a plurality of holes for inserting a plurality of screws to aid in retaining the floor-to-ceiling polycarbonate pole to a floor, the first protective rubber tip engaging a top part of said polycarbonate floor-to-ceiling pole to retain it to a ceiling and the second protective rubber tip engaging a bottom part of the polycarbonate floor-to-ceiling pole to retain it to a floor; (b) wrapping a wire grid shell having a plurality of apertures around the polycarbonate floor-to-ceiling pole, the wire grid held in place using a plurality of screws, each screw having a head that is larger than each of the apertures and a body, and each screw inserted into an aperture such that the body of the screw engages a screw retention mechanism disposed on the polycarbonate floor-to-ceiling pole; and (c) placing a plurality of pegboard-style hooks, wherein each pegboard-style hook inserted into an aperture, and each pegboard-style hook having a clamp to retain a pair of shoes.

The present invention provides a floor-to-ceiling pole with a metal grid shell upon which to hang pegboard-style hooks with attached clamps. Clamps are to hold individual pairs of boots. The hooks can be placed on the pole as needed by an individual. In one example, approximately one dozen hooks with attached clamps will be shipped with the system. The grid can be detached via screws at the top and bottom for cleaning.

### BRIEF DESCRIPTION OF THE DRAWINGS

FIG. 1A illustrates a view of the system which comprises a floor-to-ceiling pole with a metal grid shell.

FIG. 1B illustrates a top view of the present invention's system depicting a grid shell closed by screws, attached to pole.

FIG. 2 illustrates the methodology involved in removing the grid shell (for example, removal for cleaning) via removing the screws.

FIG. 3 illustrates the removed grid.

FIG. 4 illustrates a view of the top of the pole, without the grid shell, and including a rubber tip that will affix to the ceiling and screw retention mechanisms.

FIG. 5 illustrates a detailed view of the base of the pole, without the attached grid, depicting metal base being screwed into floor (using screws) for stability.

FIG. 6 illustrates the grid and the pole prior to assembly.

FIG. 7 illustrates two lengths of hooks to be included, with a pair of boots attached as an example.

FIG. 8 illustrates a detailed view of sample pegboard-style hooks with attached clamps, shown in 2 lengths, as per one embodiment of the invention.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention provides a floor-to-ceiling pole with a metal grid shell upon which to hang pegboard-style hooks with attached clamps. Clamps are to hold individual pairs of boots. The hooks can be placed on the pole as needed by an individual. In one non-limiting example, the floor-to-ceiling pole is made from polycarbonate.

In one example, approximately one dozen hooks with attached clamps will be shipped with the system. The grid can be detached via screws at the top and bottom for cleaning.

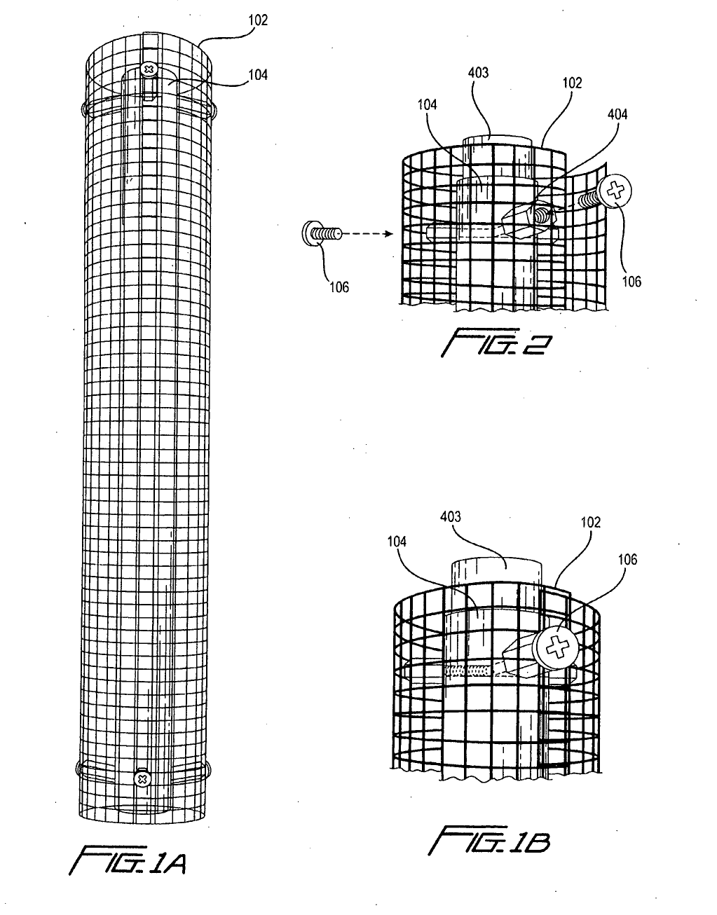

FIG. 1A illustrates a view of the system which comprises a floor-to-ceiling pole 104 with a metal grid shell 102. FIG. 1B illustrates a top view of the present Invention's system depicting grid shell 102 closed by screws 106, attached to pole 104.

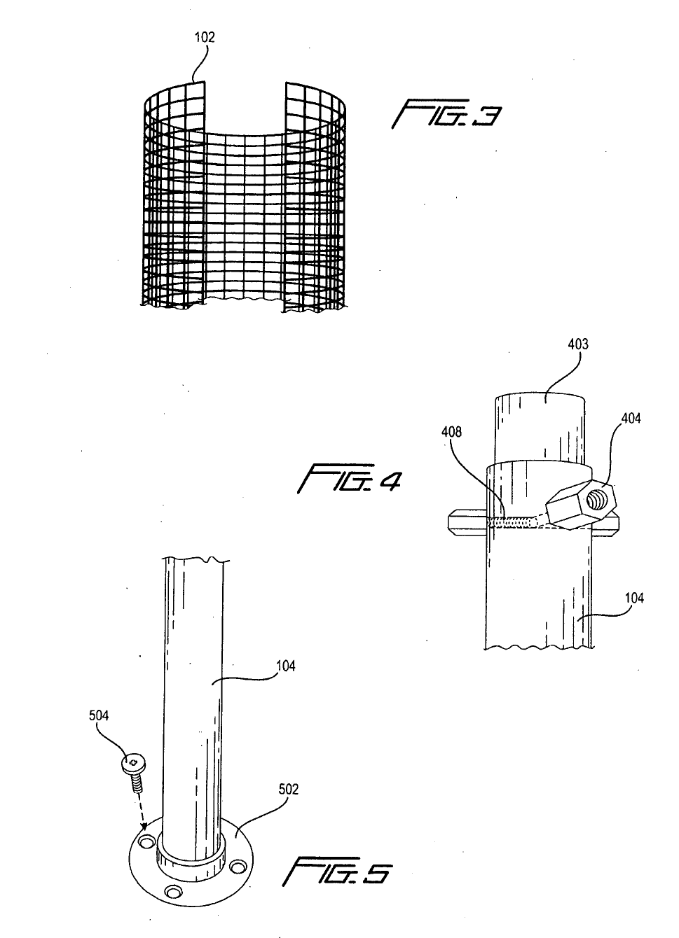

FIG. 2 illustrates the methodology involved in removing the grid shell 102 (for example, removal for cleaning) via removing the screws 106 and disengaging the screws 106 from the screw retaining mechanism. As shown in FIG. 2, each of the screws 106 has a head that is larger than the grid apertures and a body that fits through the grid apertures to engage a screw retention mechanism 404. The screw retention mechanism 404 is a threaded structure that receives and retains the screws 106. The screws 106 and the screw retention mechanism 404 form a male-female relationship. Also, as shown in FIG. 2, the pole 104 can be capped at one or both ends with a rubber tip 403. The rubber tip prevents any damage (in a similar manner as a bumper guard protects an automobile) that could be caused by pole 104 on the wall (e.g., a ceiling wall) or any structure that abuts the pole. As mentioned above, the rubber cap can be located on the top and bottom of the floor. The rubber cap is engaged to the pole via a coupling or any male-female engagement mechanism (for example, a male component on rubber tip 403 engaging and locking into a female component located on the top of the pole 104, or vice versa). In one embodiment, the rubber caps have a suction-cup surface that engages the wall.

FIG. 3 illustrates the removed grid 102.

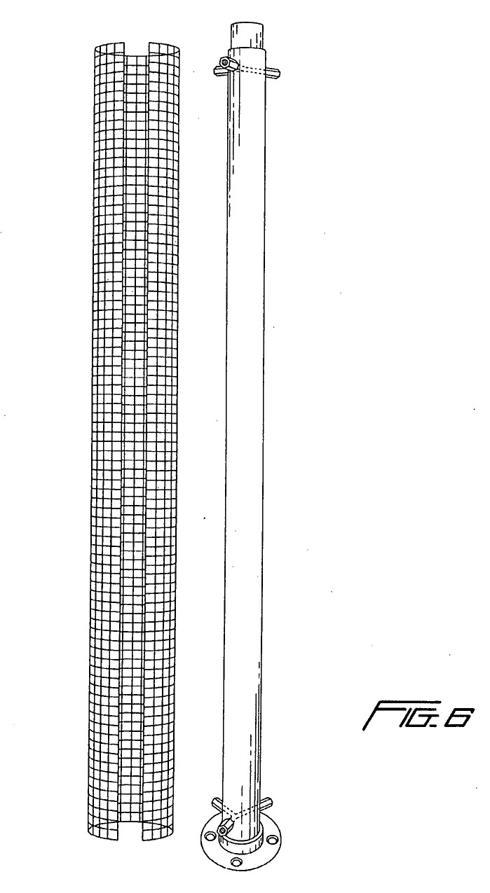

FIG. 4 illustrates a view of the top of the pole 104, without the grid shell, and including a rubber tip 403 that will affix to the ceiling and screw retention mechanisms 404. The screw retention mechanism 404 is held in place in the pole by pre-formed grooves that are made on the pole 404. In one embodiment, there are two sets of screw retention mechanisms, the first set located near the top of pole 104 and a second set located at the bottom of pole 104.

FIG. 5 illustrates a detailed view of the base of the pole 104, without the attached grid, depicting, in one embodiment, the metal or steel base 502 being screwed into floor (using screws 504) for stability. Although not shown, it should be noted that the pole 104 can be equipped with a rubber tip for protecting the pole 104 from damaging the floor (or any other structure that may abut the pole 104). The pole 104 slides into the aperture of the base 502.

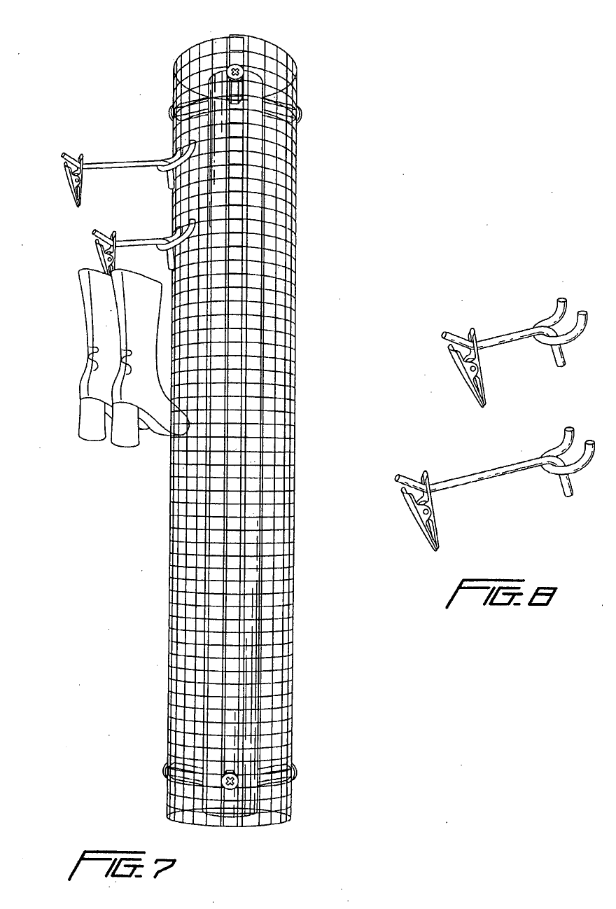

FIG. 6 illustrates the grid and the pole prior to assembly.

FIG. 7 illustrates two lengths of hooks to be included, with a pair of boots attached as an example.

FIG. 8 illustrates a detailed view of sample pegboard-style hooks with attached clamps, shown in 2 lengths, as per one embodiment of the invention.

The present invention provides for a vertical boot storage system comprising: (a) a floor-to-ceiling pole 104 (made of, for example, polycarbonate) having a plurality of screw retention mechanisms 404 disposed thereon, (b) a base 502 (made, for example, from steel) having an aperture that engages with a bottom part of the floor-to-ceiling pole 104 to retain it to a floor; (c) a wire grid shell 102 (made, for example, of metal or plastic) having a plurality of apertures (e.g., square or rectangular apertures) wrapped around the floor-to-ceiling pole 104, the wire grid shell 102 held in place using a plurality of screws 106, each screw 106 having a head that is larger than each of the apertures and a body, and each screw 106 inserted into an aperture such that the body of the screw engages a screw retention mechanism 404 disposed on the floor-to-ceiling pole 104; and (d) a plurality of hooks (e.g., pegboard-style hooks), each hook inserted into an aperture, and each hook having a clamp to retain a pair of shoes. In an extended embodiment, the base 502 has a plurality of holes for inserting a plurality of screws 504 to aid in retaining said floor-to-ceiling pole to a floor. In another extended embodiment, the floor-to-ceiling pole has a protective rubber tip that is located at the top and/or bottom of the floor-to-ceiling pole 104.

In one exemplary embodiment, a first set of screw retention mechanisms are disposed in close proximity to the top part of the floor-to-ceiling pole and a second set of screw retention mechanisms are disposed in close proximity to the bottom part of said floor-to-ceiling polycarbonate pole (see FIG. 6, wherein there are two sets of retention mechanisms, one near the top of the floor-to-ceiling pole and another near the bottom of the floor-to-ceiling pole).

The present invention also provides for a vertical boot storage system comprising: (a) a floor-to-ceiling polycarbonate pole 104 having a plurality of screw retention mechanisms 404 disposed thereon; (b) a base 502 engaging with a bottom part of the floor-to-ceiling polycarbonate pole 104 to retain it to a floor, the base 502 having a plurality of holes for inserting a plurality of screws 504 to aid in retaining the floor-to-ceiling polycarbonate pole 104 to a floor; (c) a first protective rubber tip 403 engaging a top part of the polycarbonate floor-to-ceiling pole 104 to retain it to a ceiling and a second protective rubber tip (not shown) engaging a bottom part of the polycarbonate floor-to-ceiling pole 104 to retain it to a floor; (d) a wire grid shell 102 having a plurality of apertures wrapped around the polycarbonate floor-to-ceiling pole 104, the wire grid shell 102 held in place using a plurality of screws 106, each screw 106 having a head that is larger than each of the apertures and a body, and each screw 106 inserted into an aperture among such that the body of the screw engages a screw retention mechanism 404 disposed on the polycarbonate floor-to-ceiling pole 104; and (e) a plurality of pegboard-style hooks, each pegboard-style hook inserted into an aperture, and each pegboard-style hook having a clamp to retain a pair of shoes.

The present invention also provides for a method of assembling a vertical boot storage comprising: (a) assembling a floor-to-ceiling polycarbonate pole 104 with a base 502 and a first and second protective rubber tips, the floor-to-ceiling polycarbonate pole 104 having a plurality of screw retention mechanisms 404 disposed thereon, the base 502 engaging with a bottom part of the floor-to-ceiling polycarbonate pole 104 to retain it to a floor, the base 502 having a plurality of holes for inserting a plurality of screws 504 to aid in retaining the floor-to-ceiling polycarbonate pole 104 to a floor, the first protective rubber tip engaging a top part of said polycarbonate floor-to-ceiling pole 104 to retain it to a ceiling and a second protective rubber tip (not shown) engaging a bottom part of the polycarbonate floor-to-ceiling pole 104 to retain it to a floor; (b) wrapping a wire grid shell 102 having a plurality of apertures around the polycarbonate floor-to-ceiling pole 104, the wire grid held in place using a plurality of screws 106, each screw 106 having a head that is larger than each of the apertures and a body, and each screw 106 inserted into an aperture such that the body of the screw 106 engages a screw retention mechanism 404 disposed on the polycarbonate floor-to-ceiling pole 104; and (c) placing a plurality of pegboard-style hooks, wherein each pegboard-style hook inserted into an aperture, and each pegboard-style hook having a clamp to retain a pair of shoes.

Although throughout the specification, the invention is described with regards to a vertical floor-to-ceiling pole, it should be noted that the device of the present invention can be used, without modification, to extend horizontally from a wall-to-wall (or any barrier-to-barrier). Such implementations are within the scope of the present invention. Also, although the specification refers to using the structure to hold shoes, it should be noted that other items (such as, for example, purses, bags, etc.) can also be hung from the device of the present invention. The variations in the item stored should not be used to limit the scope of the present invention.

### CONCLUSION

An apparatus has been shown in the above embodiments for the effective implementation of a vertical boot storage system. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by size of the hooks used, type of materials of the mesh or pole, specific item being hung (e.g., shoes), or specific manufacturing techniques.

1. A vertical boot storage system comprising:
a. a floor-to-ceiling pole having a plurality of screw retention mechanisms disposed thereon;
b. a base engaging with a bottom part of said floor-to-ceiling pole to retain it to a floor;
c. a wire grid shell having a plurality of apertures wrapped around said floor-to-ceiling pole, said wire grid held in place using a plurality of screws, each screw having a head that is larger than each of said plurality of apertures and a body, and each screw inserted into an aperture among said plurality of apertures such that the body of the screw engages a screw retention mechanism among said plurality of screw retention mechanisms disposed on said floor-to-ceiling pole; and
d. a plurality of hooks, each hook among said plurality of hooks inserted into an aperture among said plurality of apertures, and each hook among said plurality of hooks having a clamp to retain a pair of shoes.

2. The vertical boot storage of claim 1, wherein a first set of screw retention mechanisms among said plurality of screw retention mechanisms are disposed in close proximity to a top part of said floor-to-ceiling pole and a second set of screw retention mechanisms among said plurality of screw retention mechanisms are disposed in close proximity to a bottom part of said floor-to-ceiling pole.

3. The vertical boot storage of claim 1, wherein said floor-to-ceiling pole has first and second protective rubber tips, said first protective rubber tip engaging a top part of the polycarbonate floor-to-ceiling pole to retain it to a ceiling and a second protective rubber tip engaging a bottom part of the polycarbonate floor-to-ceiling pole to retain it to a floor.

4. The vertical boot storage of claim 1, wherein said base is a metal base.

5. The vertical boot storage of claim 1, wherein said floor-to-ceiling pole is made of polycarbonate.

6. The vertical boot storage of claim 1, wherein said apertures are any of the following: square or rectangular.

7. The vertical boot storage of claim 1, wherein each hook among said plurality of hooks is a pegboard-style hook.

8. The vertical boot storage of claim 1, wherein said wire grid shell is made of metal.

9. The vertical boot storage of claim 1, wherein said wire grid shell is made of plastic.

10. The vertical boot storage of claim 1, wherein said base has a plurality of holes for inserting a plurality of screws to aid in retaining said floor-to-ceiling pole to a floor.

11. A vertical boot storage system comprising:
a. a floor-to-ceiling polycarbonate pole having a plurality of screw retention mechanisms disposed thereon;
b. a base engaging with a bottom part of said floor-to-ceiling polycarbonate pole to retain it to a floor, said base having a plurality of holes for inserting a plurality of screws to aid in retaining said floor-to-ceiling polycarbonate pole to a floor;
c. a first protective rubber tip engaging a top part of said polycarbonate floor-to-ceiling pole to retain it to a ceiling and a second protective rubber tip engaging a bottom part of said polycarbonate floor-to-ceiling pole to retain it to a floor;
d. a wire grid shell having a plurality of apertures wrapped around said polycarbonate floor-to-ceiling pole, said wire grid held in place using a plurality of screws, each screw having a head that is larger than each of said plurality of apertures and a body, and each screw inserted into an aperture among said plurality of apertures such that the body of the screw engages a screw retention mechanism among said plurality of screw retention mechanisms disposed on said polycarbonate floor-to-ceiling pole; and
e. a plurality of pegboard-style hooks, each pegboard-style hook among said plurality of pegboard-style hooks inserted into an aperture among said plurality of apertures, and each pegboard-style hook among said plurality of pegboard-style hooks having a clamp to retain a pair of shoes.

12. The vertical boot storage of claim 11, wherein said apertures are any of the following: square or rectangular.

13. The vertical boot storage of claim 11, wherein said wire grid shell is made of metal.

14. The vertical boot storage of claim 11, wherein said wire grid shell is made of plastic.

15. The vertical boot storage of claim 11, wherein a first set of screw retention mechanisms among said plurality of screw retention mechanisms are disposed in close proximity to said top part of said floor-to-ceiling polycarbonate pole and a second set of screw retention mechanisms among said plurality of screw retention mechanisms are disposed in close proximity to said bottom part of said floor-to-ceiling polycarbonate pole.

16. The vertical boot storage of claim 11, wherein said base is a metal base.

17. A method of assembling a vertical boot storage comprising:
a. assembling a floor-to-ceiling polycarbonate pole with a base and a first and second protective rubber tips, said floor-to-ceiling polycarbonate pole having a plurality of screw retention mechanisms disposed thereon, said base engaging with a bottom part of said floor-to-ceiling polycarbonate pole to retain it to a floor, said base having a plurality of holes for inserting a plurality of screws to aid in retaining said floor-to-ceiling polycarbonate pole to retain it to a floor, said first rubber tip engaging a top part of said polycarbonate floor-to-ceiling pole to retain it to a ceiling and a second protective rubber tip engaging a bottom part of said polycarbonate floor-to-ceiling pole to retain it to a floor;
b. wrapping a wire grid shell having a plurality of apertures around said polycarbonate floor-to-ceiling pole, said wire grid held in place using a plurality of screws, each screw having a head that is larger than each of said plurality of apertures and a body, and each screw inserted into an aperture among said plurality of apertures such that the body of the screw engages a screw retention mechanism among said plurality of screw retention mechanisms disposed on said polycarbonate floor-to-ceiling pole; and
c. placing a plurality of pegboard-style hooks, wherein each pegboard-style hook among said plurality of pegboard-style hooks inserted into an aperture among said plurality of apertures, and each pegboard-style hook among said plurality of pegboard-style hooks having a clamp to retain a pair of shoes.

18. The method of claim 17, wherein said apertures are any of the following: square or rectangular.

19. The method of claim 17, wherein said wire grid shell is any of the following: metal wire grid shell or plastic wire grid shell.

20. The method of claim 17, wherein a first set of screw retention mechanisms among said plurality of screw retention mechanisms are disposed in close proximity to said top part of said floor-to-ceiling polycarbonate pole and a second set of screw retention mechanisms among said plurality of screw retention mechanisms are disposed in close proximity to said bottom part of said floor-to-ceiling polycarbonate pole.
